(19) United States
(12) Patent Application Publication
(10) Pub. No.: US 2016/0344076 A1
(43) Pub. Date: Nov. 24, 2016

(54) METAL AIR BATTERY AND METHOD OF OPERATING THE METAL AIR BATTERY

(71) Applicant: Samsung Electronics Co., Ltd., Suwon-si (KR)

(72) Inventors: Eunha Park, Seoul (KR); Jungock Park, Yongin-si (KR); Dongjoon Lee, Suwon-si (KR); Heungchan Lee, Seongnam-si (KR); Dongmin Im, Seoul (KR)

(21) Appl. No.: 15/145,873

(22) Filed: May 4, 2016

(30) Foreign Application Priority Data
May 19, 2015 (KR) 10-2015-0069794

(51) Int. Cl. H01M 12/02; H01M 12/08

(52) U.S. Cl. CPC H01M 12/02; H01M 12/08

(57) ABSTRACT

A metal air battery includes a battery cell module configured to generate electricity based on oxidation of a metal and reduction of oxygen; a first air purification module in fluid communication with the battery cell module and configured to supply stabilized air to the battery cell module when the metal air battery is charged; and a second air purification module in fluid communication with the battery cell module and configured to supply purified air to the battery cell module when the metal air battery is discharged.

### CROSS-REFERENCE TO RELATED APPLICATION

This application claims priority to and the benefit of Korean Patent Application No. 10-2015-0069794, filed on May 19, 2015, in the Korean Intellectual Property Office, and all the benefits accruing therefrom under 35 U.S.C. §119, the content of which in its entirety is herein incorporated by reference.

### BACKGROUND

1. Field

The present disclosure relates to a metal air battery and methods of operating the metal air battery.

2. Description of the Related Art

Metal air batteries include a plurality of metal air cells. Each of the plurality of metal air cells includes a positive electrode that may absorb and discharge ions and a negative electrode in which oxygen in air is used as an active material. Reduction and oxidation of oxygen introduced into the metal air battery from the outside occur in the positive electrode (i.e. cathode), and oxidation and reduction of a metal occur in the negative electrode (i.e. anode). Chemical energy generated in this case is converted into electrical energy and is extracted. For example, the metal air batteries absorb oxygen during discharging and discharge oxygen during charging. In this way, the metal air batteries use oxygen present in the air so that an energy density of the air metal batteries can be rapidly improved. For example, the metal air batteries may have a high energy density that is equal to or several times greater than an energy density of existing standard lithium ion battery.

In addition, the metal air batteries have a low ignition possibility caused by an abnormally high temperature, and thus have an excellent stability. The metal air batteries operate by absorption and discharging of oxygen without the use of heavy metals and thus have a low possibility of causing environmental contamination. Due to their various advantages, much research into metal air batteries has been performed. Nonetheless, there remains need for an improved metal air battery.

### SUMMARY

Provided is a metal air battery having a plurality of air purification modules in which stabilized air or purified air may be supplied to a battery cell module while charging or discharging of a metal air battery is performed. Methods of operating the metal air battery are also provided.

Additional aspects will be set forth in part in the description which follows and, in part, will be apparent from the description, or may be learned by practice of the presented exemplary embodiments.

According to an aspect, a metal air battery includes: a battery cell module configured to generate electricity based on oxidation of a metal and reduction of oxygen; a first air purification module in fluid communication with the battery cell module and configured to supply stabilized air to the battery cell module when the metal air battery is charged; and a second air purification module in fluid communication with the battery cell module and configured to supply purified air to the battery cell module when the metal air battery is discharged.

The stabilized air supplied by the first air purification module may include at least one of nitrogen (N₂), an inert gas, oxygen (O₂), and carbon oxide (CO₂), and a concentration of O₂ in the stabilized air may be less than 20%.

The stabilized air supplied by the first air purification module may include at least one of N₂ or an inert gas, and a concentration of N₂ or the inert gas in the stabilized air may be equal to or greater than 70%.

The purified air supplied by the second air purification module may include an inert gas, O₂ or CO₂, and a concentration of O₂ in the purified air may be equal to or greater than 20%.

The first and second air purification modules may be further configured to operate by at least one method of pressure swing adsorption (PSA), thermal swing adsorption (TSA), pressure thermal swing adsorption (PTSA), vacuum swing adsorption (VSA), and optional separation.

Each of the first and second air purification modules may include at least one of an adsorption material and an optional transmission layer.

The adsorption material may comprise at least one of a zeolite, alumina, silica gel, metal-organic framework (MOF), zeolitic imidazolate framework (ZIF), and activated carbon.

The metal air battery may further include: a first fluid regulation unit configured to regulate a flow of a fluid from the first air purification module to the battery cell module; and a second fluid regulation unit configured to regulate a flow of a fluid from the second air purification module to the battery cell module.

The metal air battery may further include a third fluid regulation unit configured to regulate a flow of a fluid discharged from the battery cell module to an outside of the battery cell module.

The metal air battery may further include an oxygen concentration measurement unit configured to measure a concentration of O₂ in the battery cell module.

The metal air battery may further include first and second pressurization units respectively placed in the first and second air purification modules, wherein a predetermined reference oxygen concentration and an oxygen concentration measured by the oxygen concentration measurement unit may be compared with each other for controlling the first and second fluid regulation units.

Each of the first and second fluid regulation units may be an electronically actuated valve.

The third fluid regulation unit may be a check valve.

The metal air battery may be a lithium (Li) air battery.

According to an aspect, a method of operating the metal air battery includes: setting an operation mode of the metal air battery; controlling a first fluid regulation unit and a second fluid regulation unit according to the operation mode of the metal air battery; introducing the stabilized air from the first air purification module or the purified air from the second air purification module at a uniform flow rate into the battery cell module, depending on whether the first regulation unit and the second fluid regulation unit are open or closed; measuring a concentration of oxygen (O₂) in the battery cell module; and determining whether the concentration of O₂ in the battery cell module is less than a reference oxygen concentration.

The method may further include, when the metal air battery is in a charging mode and the oxygen concentration is less than the reference oxygen concentration, maintaining or reducing a pressure of the stabilized air discharged from the first air purification module.

The method may further include, when the metal air battery is in a charging mode and the oxygen concentration is greater than the reference oxygen concentration, increasing a pressure of the stabilized air discharged from the first air purification module.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a schematic view of a metal air battery according to an exemplary embodiment;

FIG. 2 is a schematic view of a plurality of cells in a battery cell module illustrated in FIG. 1;

FIG. 3 is a block diagram illustrating a schematic configuration of components in a metal air battery according to an exemplary embodiment;

FIG. 4 is a graph of battery specific capacity (milliampere-hours per gram, mAh/g) versus cycle number showing a change in a battery capacity per unit weight according to an increase in the number of times of charging/discharging in a metal air battery according to a first embodiment (X) and metal air batteries according to first and second comparative examples (Y1, Y2);

FIG. 5 is a graph of voltage (V) versus (cycle number) showing a change in an overvoltage (V) for a metal air battery according to charging/discharging in the metal air battery according to the first embodiment and the metal air batteries according to the first and second comparative examples; and

FIG. 6 is a flowchart of a method of operating a metal air battery according to an exemplary embodiment.

### DETAILED DESCRIPTION

Reference will now be made in detail to exemplary embodiments, examples of which are illustrated in the accompanying drawings, wherein like reference numerals refer to like elements throughout. In the drawings, sizes of elements may be exaggerated for clarity and convenience of explanation. In this regard, the present exemplary embodiments may have different forms and should not be construed as being limited to the descriptions set forth herein. Accordingly, the exemplary embodiments are merely described below, by referring to the figures, to explain aspects.

Hereinafter, it will be understood that when an element is referred to as being “above” or “on” another element, it may be directly on the other element or intervening elements may be present. In contrast, when an element is referred to as being “directly on” another element, there are no intervening elements present.

It will be understood that although the terms “first,” “second,” etc. may be used herein to describe various components, these components should not be limited by these terms. These components are only used to distinguish one component from another. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an” and “the” are intended to include the plural forms as well, including “at least one,” unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be further understood that when a unit is referred to as “comprising” an element, the unit does not exclude another element but may further include another element unless specifically oppositely indicates. Expressions such as “at least one of,” when preceding a list of elements, modify the entire list of elements and do not modify the individual elements of the list. “At least one” is not to be construed as limiting “a” or “an.” “Or” means “and/or.” As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

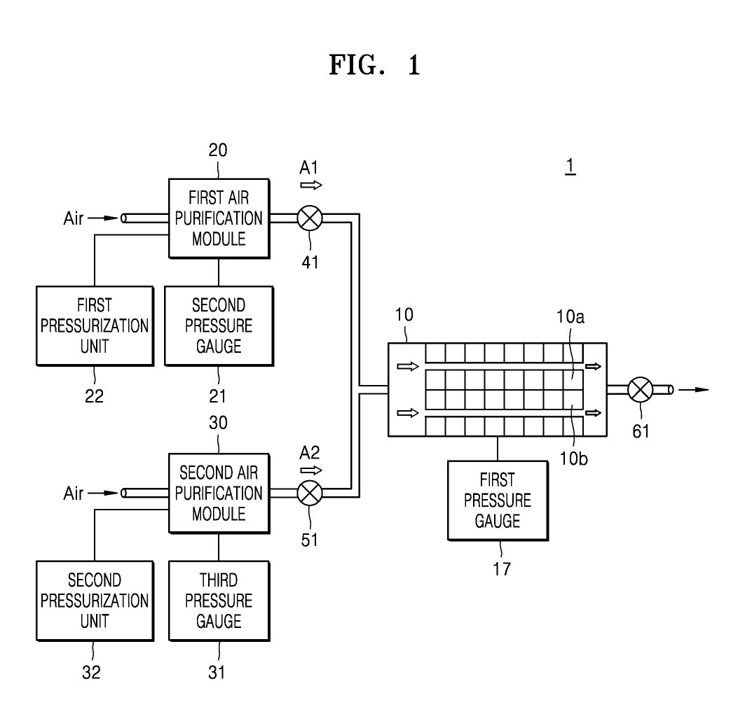

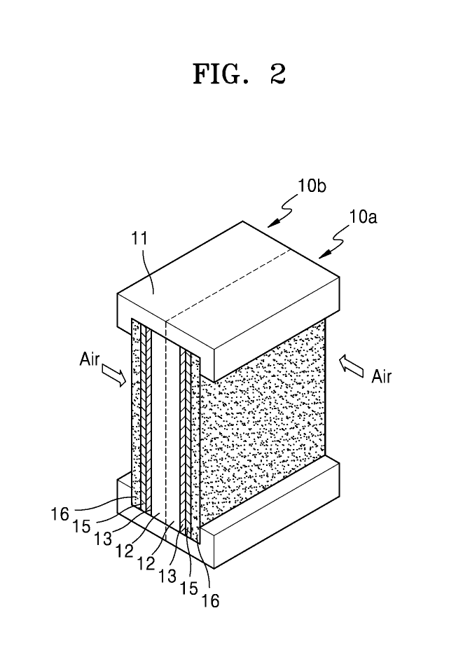

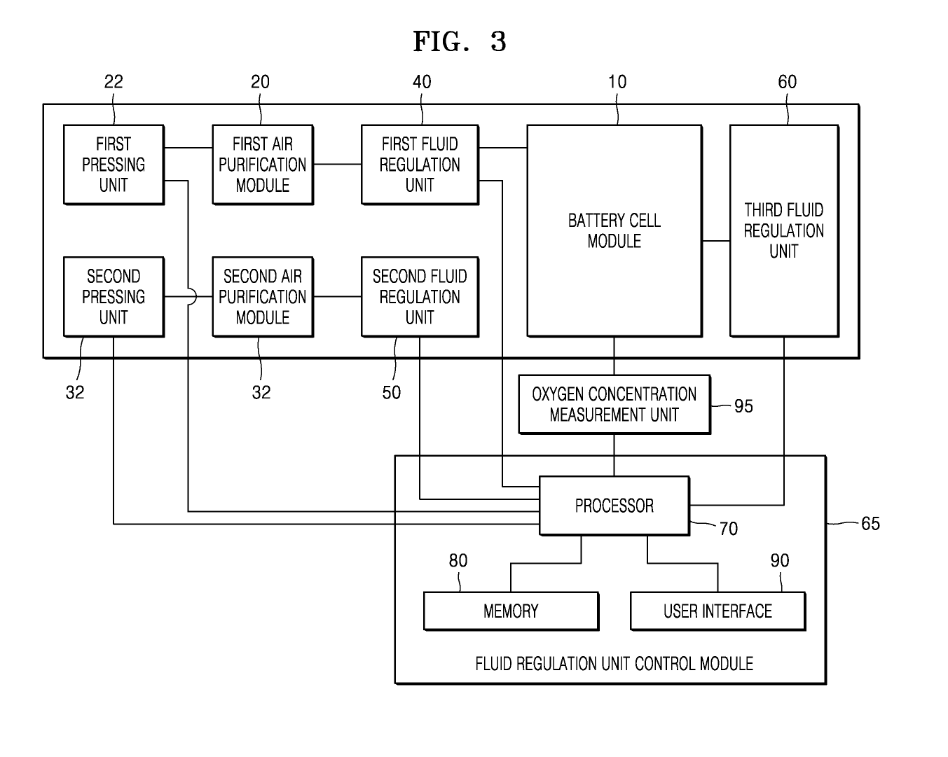

FIG. 1 is a schematic view of a metal air battery 1 according to an exemplary embodiment, and FIG. 2 is a schematic view of a plurality of cells 10a and 10b in a battery cell module 10 illustrated in FIG. 1. FIG. 3 is a block diagram illustrating a schematic configuration of the metal air battery 1 illustrated in FIG. 1.

Referring to FIGS. 1 through 3, the metal air battery 1 according to the embodiment may include a battery cell module 10, a first air purification module 20, a second air purification module 30, a first fluid regulation unit 40, a second fluid regulation unit 50, and a third fluid regulation unit 60. The battery cell module 10 may generate electricity by the oxidation of a metal and the reduction of oxygen. For example, when the metal is lithium (Li), the metal air battery 1 may generate electricity through a reaction in which Li and oxygen react with each other and lithium peroxide (Li₂O₂) is generated when the metal air battery 1 is discharged, as shown in the following Reaction Formula 1, or may discharge Li ions and oxygen when Li₂O₂ is decomposed when the metal air battery 1 is charged, as shown in the following Reaction Formula 2.

2Li+2e⁻+O₂→Li₂O₂ Reaction formula 1

Li₂O₂→2Li⁺+2e⁻+O₂ Reaction formula 2

However, the metal used in the metal air battery 1 is not limited to Li and may comprise at least one of sodium (Na), zinc (Zn), potassium (K), calcium (Ca), magnesium (Mg), iron (Fe), aluminum (Al), and an alloy thereof.

The battery cell module 10 may include a plurality of cells 10a and 10b. The plurality of cells 10a and 10b may include a housing 11, a negative electrode metal layer 12, a negative electrode electrolyte layer 13, a positive electrode layer 15, and a gas diffusion layer 16.

The housing 11 may accommodate the negative electrode metal layer 12, the negative electrode electrolyte layer 13, the positive electrode layer 15, and the gas diffusion layer 16, and may seal them together.

The negative electrode metal layer 12 may absorb and discharge metallic ions. The negative electrode metal layer 12 may include, for example, at least one of Li, Na, Zn, K, Ca, Mg, Fe, Al, and an alloy thereof.

The negative electrode electrolyte layer 13 may transfer the discharged metallic ions to the positive electrode layer 15. To this end, the negative electrode electrolyte layer 13 may include an electrolyte. In an example, the electrolyte may be a solid phase including at least one of a polymer-based electrolyte, an inorganic electrolyte, and a composite electrolyte or may be formed by dissolving metallic salts in a solvent.

The positive electrode layer 15 may include an electrolyte for conduction of metallic ions, a catalyst for oxidation and reduction of oxygen, a conductive material, and a binder. For example, after an electrolyte, catalyst, conductive material, and binder are mixed, a solvent is added to the mixture so that a positive electrode slurry may be manufactured. The positive electrode slurry may be applied onto the gas diffusion layer 16 and then may be dried to form the positive electrode layer 15. The solvent may be the same as a solvent used to manufacture the electrolyte included in the negative electrode electrolyte layer 13.

The gas diffusion layer 16 may supply purified air evenly across the positive electrode layer 15. The gas diffusion layer 16 may include at least one of a metal having a porous structure, a ceramic material, a polymer, and a carbon material. The gas diffusion layer 16 has a porous structure, thereby absorbing air discharged from the air purification module 20 and smoothly diffuses the adsorbed air into a cavity formed in the gas diffusion layer 16.

The first and second air purification modules 20 and 30 may be disposed directly in fluid communication with the battery cell module 10 and may be a gas supply device that may supply stabilized air A1 or purified air A2 to the battery cell module 10. Atmospheric air contains approximately 21% oxygen, 77% nitrogen, 0.8% argon, and 1.2% of other gases in addition to a small amount of water vapor. The first and second air purification modules 20 and 30 may optionally concentrate and supply the stabilized air A1 or the purified air A2 when the metal air battery 1 is charged or discharged.

In an example, the first air purification module 20 may remove an impurity, such as water and carbon dioxide (CO₂) from the air and may filter out the oxygen (O₂), thereby concentrating nitrogen (N₂) or an inert gas, such as argon (Ar) or helium (He) in the stabilized air A1, and supplying the concentrated stabilized air A1 to the battery cell module 10. In this case, a concentration of O₂ in the stabilized air A1 may be less than 20 volume percent (vol %), e.g., 15 vol % to 20 vol %, and may be equal to or greater than 70 vol % of a total volume of N₂ or the inert gas. In addition, the second air purification module 30 may remove the impurity, such as water and CO₂ from the air, and may filter out N₂ or the inert gas, thereby concentrating the oxygen in the purified air A2, and supplying the concentrated purified air A2 to the battery cell module 10. In this case, the concentration of O₂ in the purified air A2 may be equal to or greater than 20 vol %, e.g., 20 vol % to 30 vol %.

The first and second air purification modules 20 and 30 may be each independently configured to be operated by at least one of pressure swing adsorption (PSA), thermal swing adsorption (TSA), pressure thermal swing adsorption (PTSA), vacuum swing adsorption (VSA), an optionally by a separation technique that uses an optional separation layer.

In the present specification, PSA refers to a technique by which a particular gas is primarily adsorbed or captured by an adsorption material at a high partial pressure and when the partial pressure is reduced, the particular gas is desorbed or discharged. “TSA” refers to a technique by which the particular gas is primarily adsorbed or captured by the adsorption material at a room temperature and when temperature rises, the particular gas is desorbed or discharged. “PTSA” refers to a technique which combines PSA and TSA, and “VSA” refers to a technique by which a particular gas is primarily adsorbed or captured by the adsorption material under atmospheric pressure and the particular gas is desorbed or discharged under vacuum.

The adsorption material used in PSA, TSA, PTSA, or VSA may optionally adsorb impurities in the air. The adsorption material may be at least one selected from zeolite, alumina, slica gel, metal-organic framework (MOF), zeolitic imidazolate framework (ZIF), and activated carbon. In the present specification, “MOF” refers to a crystalline compound that includes metallic ions or a metallic cluster included in organic molecules, and which forms a primary, secondary, or tertiary structure having porosity. In addition, in the present specification, “ZIF” refers to a nanoporous compound including a tetrahedral cluster of metal ions have a structure of MN₄ (where M is a metal), and linked together by an imidazolate ligand.

An optional transmission layer used in the optional separation technique optionally transmits the remaining components except for the impurity in the air. The optional transmission layer may include a plurality of ion exchange hollow fibers arranged in parallel, i.e., arranged in parallel to a flow direction of the air.

As described above, while the air from outside of the metal air battery is introduced into the first and second air purification modules 20 and 30 and passes through the first and second air purification modules 20 and 30, the impurities included in the air may be removed. In addition, when the metal air battery 1 is charged or discharged, the stabilized air A1, including a concentrated stabilized gas such as N₂ or Ar, and the purified air A2 may be supplied to the battery cell module 10. For example, the stabilized air A1 includes O₂ in a concentration of less than 20 vol %, e.g., 15 vol % to 20 vol %, and the inert gas in a concentration equal to or greater than 70 vol %, e.g., 70 vol % to 90 vol %, and the purified air A2 includes concentrated O₂ in a concentration equal to or greater than 20 vol %, e.g., 20 vol % to 30 vol %. However, embodiments are not limited thereto, and a nitrogen tank or an inert gas tank and an oxygen tank may be connected to the first and second air purification modules 20 and 30, respectively, so that nitrogen or the inert gas and O₂ may be directly introduced into the battery cell module 10. In this way, when the metal air battery 1 is charged or discharged, the stabilized air A1 and the purified air A2 are supplied to the battery cell module 10 so that an energy density of the metal air battery 1 may be increased. Thus, a lifetime of the metal air battery 1 may be prevented from being shortened, and energy efficiency of the metal air battery 1 may be improved.

First and second pressurization units 22 and 32 may be disposed in the first and second air purification modules 20 and 30, respectively, and may change the pressure of the stabilized air A1 or the purified air A2 discharged from the first and second air purification modules 20 and 30. In one example, when the metal air battery 1 is charged or discharged, the first and second pressurization units 22 and 32 may receive control signals from a processor 70 (described below) and may control a flow rate of the stabilized air A1 or the purified air A2 discharged from the first and second air purification modules 20 and 30. In addition, the first and second pressurization units 22 and 32 may be formed as pressurization pumps. However, embodiments are not limited thereto.

When the metal air battery 1 is discharged, as known from the above-described Reaction Formula 1, air is supplied to the positive electrode, and oxygen molecules are used as an active material. In this case, impurities included in the air, such as H₂O and CO₂, may disturb the formation of a metal peroxide, for example, Li₂O₂, and may lower the capacity and the lifetime of the metal air battery 1.

In addition, when the metal air battery 1 is charged, as known from the above-described Reaction Formula 2, oxygen is continuously generated from the positive electrode. Thus, the amount of oxygen in the battery cell module 10 may be increased. Thus, it may be difficult for the chemical reaction of Reaction Formula 2 to occur. As a result, charging efficiency of the metal air battery 1 may be lowered. Thus, when the metal air battery 1 is charged or discharged, the stabilized air A1 or the purified air A2 may be supplied to the battery cell module 10, and the impurities included in the battery cell module 10 may be properly discharged to the outside according to a usage condition of the metal air battery 1 and an internal condition of the battery cell module 10.

The first and second fluid regulation units 40 and 50 are blocking devices disposed between the battery cell module 10 and the first and second air purification modules 20 and 30, respectively. The first and second fluid regulation units 40 and 50 may regulate fluid communication that occurs between the battery cell module 10 and the first and second air purification modules 20 and 30.

In one example, the first and second fluid regulation units 40 and 50 may be first and second electronically actuated valves 41 and 51. The first and second electronically actuated valves 41 and 51 control flow of a fluid supplied from the first and second air purification modules 20 and 30 to the battery cell module 10. The first and second electronically actuated valves 41 and 51 may be actuated by a solenoid that is an electronic driving device. Opening and closing of the first and second electronically actuated valves 41 and 51 may be controlled by turning on/off pulse-shaped excitation currents transferred to the solenoid. As opening and closing times of the first and second electronically actuated valves 41 and 51 are controlled in response to the control signals output from the processor 70, the supply of the fluid from the first and second air purification modules 20 and 30 may be controlled to have high accuracy and high responsiveness.

The third fluid regulation unit 60 is a blocking device that may be configured to regulate flow of the fluid discharged from the battery cell module 10 to the outside of the battery cell module. For example, the third fluid regulation unit 60 may be disposed in a discharging path of the battery cell module 10 and may regulate fluid communication between the battery cell module and an outside of the battery cell module 10.

In one example, the third fluid regulation unit 60 may be a third electronically actuated valve 61. The third electronically actuated valve 61 may be actuated in a predetermined cycle to periodically control the flow of the fluid discharged from the battery cell module 10 to the outside of the battery cell module 10. In addition, the third fluid regulation unit 60 may be formed as a check valve so that the direction of fluid communication may be regulated in a single direction. In one example, when the third fluid regulation unit 60 including the check valve shape is disposed between the battery cell module 10 and the outside of the battery cell module 10, a gas in the battery cell module 10 is discharged from the battery cell module 10 to the outside of the battery cell module 10, whereas external air may not be introduced into the battery cell module 10 from the outside.

A fluid regulation unit control module 65 is a control device that transmits control signals to the first through third fluid regulation units 40, 50, and 60 and controls opening and closing of the first through third fluid regulation units 40, 50, and 60. In one example, the fluid regulation unit control module 65 may include the processor 70, memory 80, and a user interface 90.

The processor 70 may be hardware that controls an overall function and an operation of the metal air battery 1. In one example, the processor 70 may execute a program stored in the memory 80 and may control the first through third fluid regulation units 40, 50, and 60 depending upon a usage state of the metal air battery 1. In addition, the processor 70 may perform a control operation on the first through third fluid regulation units 40, 50, and 60, by controlling an oxygen concentration measurement unit 95 (described below), according to a usage mode of the metal air battery 1. The processor 70 may also process image signals so as to display the measured usage state of the metal air battery 1.

The processor 70 may be configured in the form of one microprocessor module or in the form of two or more microprocessors which are combined with each other. That is, the implementation shape of the processor 70 is not limited to any one specific design. In one example, the processor 70 may be a part of a battery management system (BMS).

A program for an operation of the metal air battery 1 and data required for implementation of the program may be stored in the memory 80. The memory 80 may include a hard disk drive (HDD), read only memory (ROM), random access memory (RAM), flash memory, and a memory card, which are storage mediums.

A program for controlling the first through third fluid regulation units 40, 50, and 60 according to a usage mode of the metal air battery 1, or a program for controlling the first through third fluid regulation units 40, 50, and 60 according to a state of the battery cell module 10 as measured by the oxygen concentration measurement unit 95, may be stored in the memory 80.

The user interface 90 may include an input unit (not shown) for receiving an input for manipulating the usage mode of the metal air battery 1 and an output unit (not shown) that may output information regarding the usage state of the metal air battery 1 as measured by the oxygen concentration measurement unit 95.

The user interface 90 may include at least one of a button, a key pad, a switch, a dial or a touch interface for manipulating the usage mode of the metal air battery 1. The user interface 90 may include a display unit for displaying an image and may be implemented with a touch screen. The display unit may include a liquid crystal display (LCD) panel or an organic light-emitting diode (OLED) panel and may display information regarding the measured usage state of the metal air battery 1 as an image or a text.

The oxygen concentration measurement unit 95 is a measurement device configured to measure an oxygen concentration O₁ of the battery cell module 10. When the metal air battery 1 receives the stabilized air A1 or the purified air A2 supplied from the first and second air purification modules 20 and 30, the oxygen concentration measurement unit 95 may measure the oxygen concentration O₁ of the battery cell module 10. In one example, the oxygen concentration measurement unit 95 may be a shading battery type or magnetic type sensor. In this case, a sensing area may be formed between a rear end of the battery cell module 10 and the first fluid regulation unit 40. However, embodiments are not limited thereto, and the oxygen concentration measurement unit 95 which measures the oxygen concentration in the battery cell module 10 may also be disposed in an alternative, arbitrary position of the battery cell module 10.

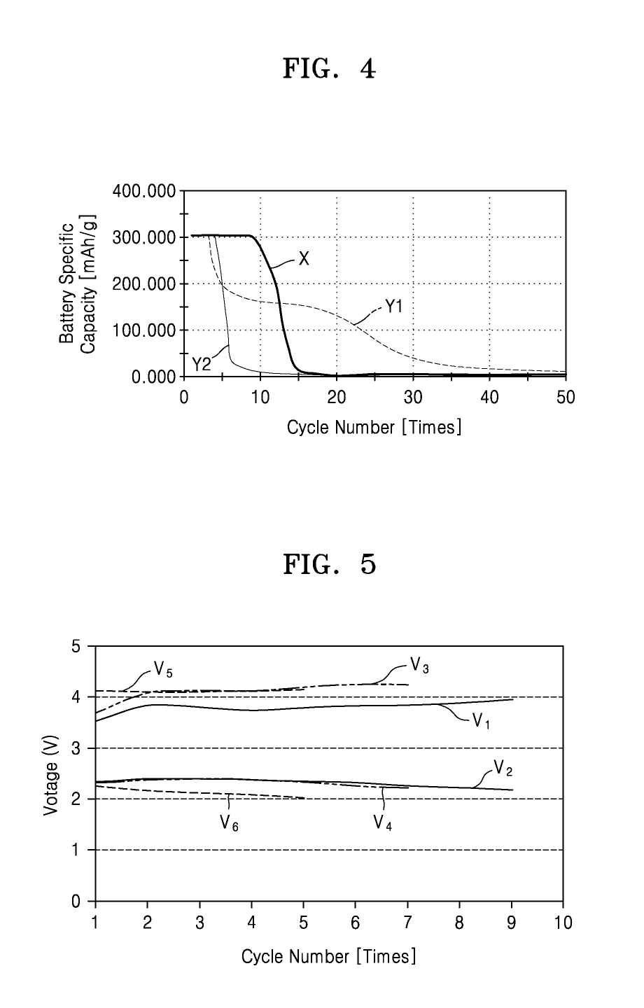

FIG. 4 is a graph showing a change in battery capacity per unit weight according to an increase in the number of times of charging/discharging for a metal air battery according to a first embodiment and metal air batteries according to first and second comparative examples, and FIG. 5 is a graph showing a change in overvoltage according to charging/discharging for the metal air battery according to the first embodiment and the metal air batteries according to the first and second comparative examples.

Referring to FIGS. 4 and 5, the first air purification module 20 of the metal air battery 1 according to a first embodiment X may filter water and O₂ and may concentrate N₂. On the other hand, the first air purification module 20 of the metal air battery 1 according to a first comparative example Y1 may filter water and N₂ and may concentrate O₂, and the first air purification module 20 of the metal air battery 1 according to a second comparative example Y2 may allow the external air to pass through the battery cell module 10 without performing a separate filtering process.

By using the first air purification module 20 according to the first embodiment X, water and O₂ may be removed from the stabilized air A1 introduced into the battery cell module 10. In one example, a concentration of N₂ in this case may be 70 vol %. In this case, a capacity per unit weight of the metal air battery 1 remains constant at 300 milliampere hours per gram (mAh/g) for nine charging/discharging cycles. In this case, a smallest difference between a charging overvoltage V₁ and a discharging overvoltage V₂ of the metal air battery 1 may be maintained.

By using the first air purification module 20 according to the first comparative example Y1, N₂ is removed from the stabilized air A1 introduced into the battery cell module 10, and O₂ is concentrated in the stabilized air A1, and a concentration of O₂ in the stabilized air A1 is 70%. In this case, a battery capacity per unit weight is rapidly decreases once the number of times of charging/discharging reaches at least about five times. In this case, a difference between a charging overvoltage V₃ and a discharging overvoltage V₄ of the metal air battery 1 may be maintained to be greater than the difference in the first comparative example Y1 and to be smaller than the difference in the second comparative example Y2.

The purified air A2 introduced into the first air purification module 20 according to the second comparative example Y2 is supplied to the battery cell module 10 without performing a separate filtering operation. The concentration of O₂ of the purified air A2 supplied to the battery cell module 10 is 20%, which is about the same concentration present in general air. In this case, the battery capacity of the metal air battery 1 per unit weight starts to decrease once the number of times of charging/discharging reaches at least four times. In this case, a greatest difference between a charging overvoltage V₅ and a discharging overvoltage V₆ of the metal air battery 1 may be maintained.

As described above, the charging/discharging cycle number of the first air purification module 20 according to the first embodiment X may be about two times greater than the charging/discharging cycle number of the first air purification module 20 according to the first and second comparative examples Y1 and Y2, and a difference between charging/discharging overvoltages V₁ and V₂ in the first embodiment X may be the smallest. Thus, when the metal air battery 1 is charged and the stabilized air A1, for example, N₂ having a high concentration is supplied to the battery cell module 10 through the first air purification module 20, the metal air battery 1 may be effectively used, and the lifetime of the metal air battery 1 may be remarkably increased.

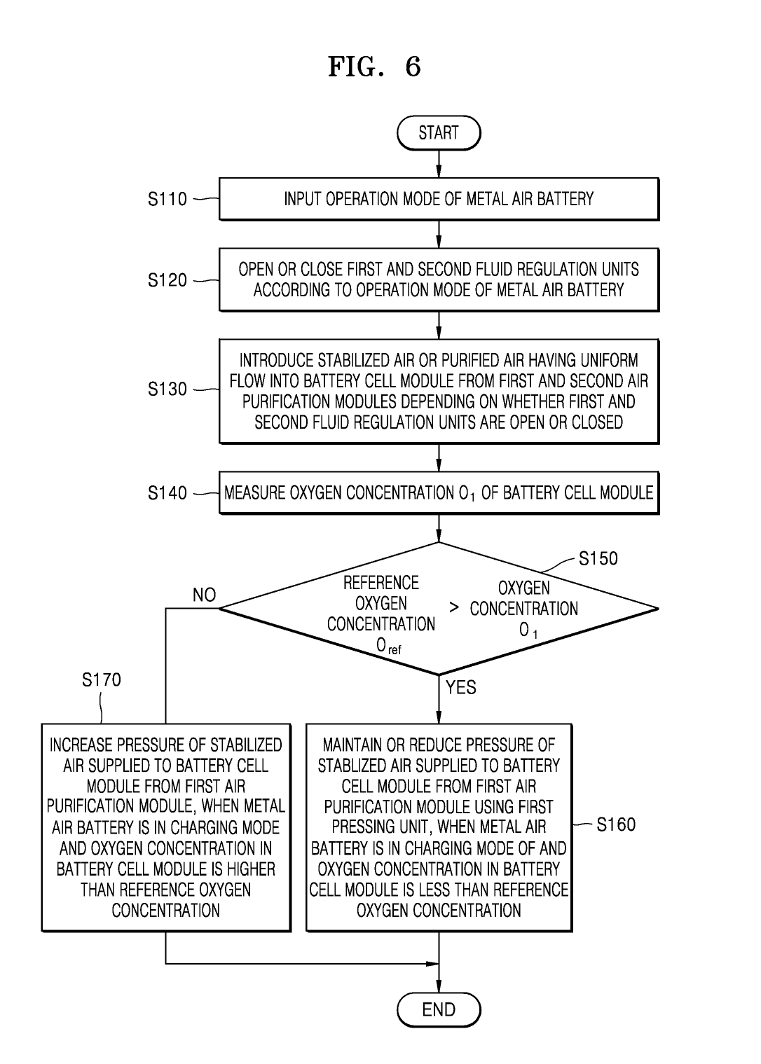

FIG. 6 is a flowchart illustrating a method of operating a metal air battery according to an exemplary embodiment.

Referring to FIGS. 3 and 6, in Operation S110, an operation mode of the metal air battery 1 is input (S110).

The metal air battery 1 may repeatedly perform charging/discharging operations according to the input operation mode. In this case, a user may input signals for determining the operation mode of the metal air battery 1 using the user interface 90, and the input signals may be transmitted to the processor 70.

In Operation S120, the first and second fluid regulation units 40 and 50 are open or closed according to the operation mode of the metal air battery 1 (S120).

It may be determined whether the first and second fluid regulation units 40 and 50 are open or closed according to the operation mode of the metal air battery 1 input through the user interface 90. In one example, when a charging mode of the metal air battery 1 is input through the user interface 90, the processor 70 may transmit control signals to the first and second fluid regulation units 40 and 50 so that the first fluid regulation unit 40 may be closed and the second fluid regulation unit 50 may be open. On the other hand, when a discharging mode of the metal air battery 1 is input through the user interface 90, the processor 70 may transmit the control signals to the first and second fluid regulation units 40 and 50 so that the first fluid regulation unit 40 may be open and the second fluid regulation unit 50 may be closed.

In Operation S130, the stabilized air A1 or the purified air A2 having uniform flow may be introduced into the battery cell module 10 from the first and second air purification modules 20 and 30 depending on whether the first and second fluid regulation units 40 and 50 are closed or open (S130).

When the metal air battery 1 is charged, the first fluid regulation unit 40 may be closed and the second fluid regulation unit 50 may be open so that the stabilized air A1 having uniform flow may be introduced into the battery cell module 10 from the first air purification module 20. In this case, an internal pressure of the battery cell module 10 may be smaller than an internal pressure of the first air purification module 20. Thus, the stabilized air A1 may be supplied to the battery cell module 10 from the first air purification module 20. In one example, when a first pressure gauge 17, a second pressure gauge 21 and the first pressurization unit 22 disposed in the battery cell module 10 and the first air purification module 20, respectively, are used and a constant pressure difference between the battery cell module 10 and the first air purification module 20 is maintained by controlling flow of the stabilized air A1 supplied from the first air purification module 20, the stabilized air having uniform flow may be supplied to the battery cell module 10 from the first air purification module 20.

When the metal air battery 1 is discharged, the first fluid regulation unit 40 may be open, and the second fluid regulation unit 50 may be closed so that the purified air A2 having uniform flow may be introduced into the battery cell module 10 from the second air purification module 30. In this case, the internal pressure of the battery cell module 10 may be smaller than the internal pressure of the second air purification module 30. Thus, the purified air A2 may be flow to the battery cell module 10 from the second air purification module 30. When a constant pressure difference between the battery cell module 10 and the second air purification module 30 is maintained using a third pressure gauge 31 and the second pressurization unit 32 is disposed in the second air purification module 30 and the first pressure gauge 17 is disposed in the battery cell module 10, the purified air A2 having uniform flow may be supplied to the battery cell module 10 from the second air purification module 30.

In Operation S140, the oxygen concentration measurement unit 95 may measure a current oxygen concentration O₁ of the battery cell module 10 (S140).

When the stabilized air A1 is supplied from the first air purification module 20 and the metal air battery 1 is charged, the oxygen concentration measurement unit 95 may measure the oxygen concentration O₁ in the battery cell module 10. When the oxygen concentration O₁ of the battery cell module 10 is measured using the oxygen concentration measurement unit 95, the stabilized air A1 may be equally supplied to the battery cell module 10 from the first air purification module 20, and the third fluid regulation unit 60 may be closed so that the fluid present in the battery cell module 10 may be discharged to the outside of the metal air battery 1.

In Operation S150, the processor 70 determines whether the oxygen concentration O₁ in the battery cell module 10 is lower than a reference oxygen concentration O_{ref} (S150).

The oxygen concentration O₁ in the battery cell module 10 is measured by the oxygen concentration measurement unit 630 and may be transferred to the processor 70. The processor 70 may compare the size of the reference oxygen concentration O_{ref}, stored in the memory 80 or input through the user interface 90, with the size of the oxygen concentration O₁ in the battery cell module 10. The processor 70 may then determine whether the oxygen concentration O₁ in the battery cell module 10 is smaller than the reference oxygen concentration O_{ref}. In this case, the reference oxygen concentration O_{ref} may be set at 20 vol %.

In Operation S160, when the oxygen concentration O₁ in the battery cell module 10 is lower than the reference oxygen concentration O_{ref} in a charging mode of the metal air battery 1, the first pressurization unit 22 may maintain or reduce the pressure of the stabilized air A1 supplied to the battery cell module 10 from the first air purification module 20 (S160).

When it is determined by the processor 70 that the oxygen concentration O₁ in the battery cell module 10 is lower than the reference oxygen concentration O_{ref} the concentration of a stabilized gas, such as N₂ or Ar, in the battery cell module 10 is sufficient. Thus, it is determined that a charging process is sufficiently performed. Accordingly, pressure applied to the stabilized air A1 discharged from the first air purification module 20 from the first pressurization unit 22 may be maintained or reduced. Thus, the speed at which the stabilized air A1 is supplied to the battery cell module 10 from the first air purification module 20 may also be maintained or reduced.

In Operation 170, when the oxygen concentration O₁ in the battery cell module 10 is higher than the reference oxygen concentration O_{ref} during the charging mode of the metal air battery 1, the first pressurization unit 22 may increase pressure of the stabilized air A1 supplied to the battery cell module 10 from the first air purification module 20 (S170).

When the processor 70 determines that the oxygen concentration O₁ in the battery cell module 10 is higher than the reference oxygen concentration O_{ref}, it is determined that the concentration of the stabilized gas, such as N₂ or Ar, in the battery cell module 10 is insufficient. Thus, it is determined that the charging process is not sufficiently performed. Accordingly, the pressure of the stabilized air A1 discharged from the first air purification module 20 by the first pressuring unit 22 may be increased. Thus, the speed at which the stabilized air A1 is supplied to the battery cell module 10 from the first air purification module 20 may also be increased. As a result, oxygen and other impurities generated in the battery cell module 10 while the metal air battery 1 is charged may be discharged to the outside of the battery cell module 10 at an increased speed. As the stabilized air A1 is supplied from the first air purification module 20 at increased speed, the amount of the stabilized gas in the battery cell module 10 may also increase. As the amount of the stabilized gas in the battery cell module 10 is increased, the oxygen concentration O₁ in the battery cell module 10 may be decreased to the level of the reference oxygen concentration O_{ref}. Thus, the charging process of the metal air battery 1 may be more smoothly performed.

A metal air battery according to an exemplary embodiment includes first and second air purification modules that may supply stabilized air and purified air depending upon whether the metal air battery is in a charging mode or a discharging mode, respectively. Thus, the metal air battery may perform charging and discharging effectively.

It should be understood that exemplary embodiments described herein should be considered in a descriptive sense only and not for purposes of limitation. Descriptions of features or aspects within each exemplary embodiment should be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A metal air battery comprising:
a battery cell module configured to generate electricity based on oxidation of a metal and reduction of oxygen;
a first air purification module in fluid communication with the battery cell module and configured to supply stabilized air to the battery cell module when the metal air battery is charged; and
a second air purification module in fluid communication with the battery cell module and configured to supply purified air to the battery cell module when the metal air battery is discharged.

2. The metal air battery of claim 1, wherein the first air purification module is configured to supply stabilized air comprising at least one of nitrogen, an inert gas, oxygen, and carbon dioxide, and a concentration of oxygen in the stabilized air is less than 20%.

3. The metal air battery of claim 1, wherein the first air purification module is configured to supply stabilized air comprising at least one of nitrogen or an inert gas, and
wherein a concentration of the nitrogen or the inert gas in the stabilized air is equal to or greater than 70%.

4. The metal air battery of claim 1, wherein the second air purification module is configured to supply purified air comprising at least one of an inert gas, oxygen or carbon dioxide, and
wherein a concentration of the oxygen in the purified air is equal to or greater than 20%.

5. The metal air battery of claim 1, wherein the first and second air purification modules are each independently configured for at least one of pressure swing adsorption, thermal swing adsorption, pressure thermal swing adsorption, vacuum swing adsorption, and separation.

6. The metal air battery of claim 5, wherein each of the first and second air purification modules comprises at least one of an adsorption material and a transmission layer.

7. The metal air battery of claim 6, wherein the adsorption material is at least one selected from zeolite, alumina, silica gel, metal-organic framework, zeolitic imidazolate framework, and activated carbon.

8. The metal air battery of claim 1, further comprising:
a first fluid regulation unit configured to regulate a flow of a fluid from the first air purification module to the battery cell module; and
a second fluid regulation unit configured to regulate a flow of a fluid from the second air purification module to the battery cell module.

9. The metal air battery of claim 1, further comprising a third fluid regulation unit configured to regulate a flow of a fluid discharged from the battery cell module to an outside of the battery cell module.

10. The metal air battery of claim 1, further comprising an oxygen concentration measurement unit configured to measure a concentration of oxygen in the battery cell module.

11. The metal air battery of claim 10, further comprising a first pressurization unit in the first air purification module and a second pressurization unit in the second air purification module, wherein a predetermined reference oxygen concentration and an oxygen concentration measured by the oxygen concentration measurement unit are compared with each other for controlling the first fluid regulation unit and the second fluid regulation unit.

12. The metal air battery of claim 8, wherein each of the first fluid regulation unit and the second fluid regulation unit is an electronically actuated valve.

13. The metal air battery of claim 9, wherein the third fluid regulation unit is a check valve.

14. The metal air battery of claim 1, wherein the metal air battery is a lithium air battery.

15. A method of operating the metal air battery of claim 1, the method comprising:
setting an operation mode of the metal air battery;
controlling a first fluid regulation unit and a second fluid regulation unit according to the operation mode of the metal air battery;
introducing the stabilized air from the first air purification module or the purified air from the second air purification module at a uniform flow rate into the battery cell module, depending on whether the first regulation unit and the second fluid regulation unit are open or closed;
measuring a concentration of oxygen in the battery cell module; and
determining whether the concentration of oxygen in the battery cell module is less than a reference oxygen concentration.

16. The method of claim 15, further comprising, when the metal air battery is in a charging mode and the oxygen concentration is less than the reference oxygen concentration, maintaining or reducing a pressure of the stabilized air discharged from the first air purification module.

17. The method of claim 15, further comprising, when the metal air battery is in a charging mode and the oxygen concentration is higher than the reference oxygen concentration, increasing a pressure of the stabilized air discharged from the first air purification module.
